(19) United States
(12) Patent Application Publication
(10) Pub. No.: US 2019/0210446 A1
(43) Pub. Date: Jul. 11, 2019

(54) Planetary Gearset System for a Motor-Vehicle Transmission, Transmission for a Motor Vehicle Having Such a Planetary Gearset System, and Drive Train for a Motor Vehicle

(71) Applicant: ZF Friedrichshafen AG, Friedrichshafen (DE)

(72) Inventors: Peter Ziemer, Tettnang (DE); Juri Pawlakowitsch, Kressbronn (DE); Thomas Rosemeier, Meckenbeuren (DE); Michael Roske, Friedrichshafen (DE)

(21) Appl. No.: 16/311,987

(22) PCT Filed: May 16, 2017
(86) PCT No.: PCT/EP2017/061706

§ 371 Date: Dec. 20, 2018

(30) Foreign Application Priority Data
Jun. 23, 2016 (DE) 10 2016 211 270.8

(51) Int. Cl. B60K 6/365; F16H 3/66; F16H 3/72; F16H 37/08; B60K 6/48; B60K 6/547; B60K 6/40

(52) U.S. Cl. CPC B60K 6/365; F16H 3/663; F16H 3/724; F16H 37/082; B60K 6/48; B60K 2006/4825; B60K 6/40; F16H 2200/201; F16H 2200/0052; F16H 2200/2043; B60K 6/547

(57) ABSTRACT

A planetary gear set system (PS, PS2) for a motor vehicle transmission (G), wherein the planetary gear set system (PS) comprises either three planetary gear sets (P1, P2, P3) or one Ravigneaux gear set (PR), and one additional planetary gear set (P23), a transmission (G) for a motor vehicle comprising such a planetary gear set system (PS, PS2), as well as a drive train for a motor vehicle comprising such a transmission (G).

### FIELD OF THE INVENTION

The invention relates generally to a planetary gear set system for a motor vehicle transmission, a transmission for a motor vehicle with such planetary gear set system, and a drive train for a motor vehicle with such transmission.

### BACKGROUND

Automatic transmissions for motor vehicles frequently include a planetary gear set system. Patent application DE 10 2012 207 017 A1, which belongs to the applicant, is mentioned by way of example; it describes a two-stage multi-stage transmission in which a first planetary gear set includes two radially nested transmission sub-stages. The inner ring gear and the outer sun gear, respectively, of this first planetary gear set are rotationally fixed to a second planetary gear set designed as a plus gear set.

Patent application DE 102 50 371 A1 describes an automatic transmission including three planetary gear sets, wherein, in FIG. 3 of this patent application, two of the planetary gear sets are combined to form one Ravigneaux gear set. A Ravigneaux gear set forms a two-carrier-four-shaft transmission and functionally consists of two planetary gear sets, wherein one of the planetary gear sets operates as a minus gear set and the other planetary gear set operates as a plus gear set. The carrier of the minus gear set is permanently connected to the carrier of the plus gear set, whereby a shared carrier is formed. A common ring gear intermeshes with the outer planet gears of the planetary gear set operating as a plus gear set, which simultaneously form planet gears of the planetary gear set operating as a minus gear set. A first sun gear intermeshes with the inner planet gears of the planetary gear set operating as a plus gear set. A second sun gear intermeshes with the planet gears of the planetary gear set operating as a minus gear set. A Ravigneaux gear set is distinguished by a small installation space requirement and simple assemblability.

Patent application DE 10 2008 041 205 A1, which belongs to the applicant, describes a multi-stage transmission having nine forward gears and one reverse gear, and also includes four planetary gear sets. In the exemplary embodiment according to FIG. 2 of this patent application, the first planetary gear set and the second planetary gear set, together, form a Ravigneaux gear set, wherein the ring gear of a minus planetary gear set marked as P4 is connected to that sun gear of the Ravigneaux gear set which intermeshes with the outer planet gears.

The transmissions known from the related art are configured for utilization in a motor vehicle drive train which is aligned transversely to the direction of travel of the motor vehicle. These types of transmissions are usually optimized with respect to a preferably short axial installation length, since the axial assembly including drive machine and transmission is to be arranged between the longitudinal members of the front end of the motor vehicle.

### SUMMARY OF THE INVENTION

Example aspects of the invention provide a planetary gear set system for a motor vehicle transmission, which is distinguished by a particularly short axial installation length.

A planetary gear set system refers to a system which is composed of multiple individual planetary gear sets. A transmission refers, in particular, to a multi-stage transmission, in which a multitude of gears, i.e., fixed translation ratios between an input shaft and an output shaft of the transmission, are preferably automatically shiftable with the aid of shift elements. In this case, the shift elements are clutches or brakes, for example. Such transmissions are utilized primarily in motor vehicles in order to adapt the rotational speed and torque output characteristic of the drive unit to the driving resistances of the vehicle in a suitable way.

A negative or minus gear set refers to a planetary gear set including a carrier, on which the planetary gears are rotatably mounted, and including a sun gear and a ring gear, wherein the tooth system of at least one of the planetary gears intermeshes both with the tooth system of the sun gear and with the tooth system of the ring gear, whereby the ring gear and the sun gear rotate in opposite directions of rotation when the sun gear rotates while the carrier is held. A positive or plus gear set differs from the above-described minus planetary gear set in that the plus gear set includes inner and outer planetary gears which are rotatably mounted on the carrier. The tooth system of the inner planetary gears intermeshes, in this case, with the tooth system of the sun gear, on the one hand, and with the tooth system of the outer planetary gears, on the other hand. In addition, the tooth system of the outer planetary gears intermeshes with the tooth system of the ring gear. As a result, the ring gear and the sun gear rotate in the same direction of rotation when the carrier is held. If a minus gear set is replaced by a plus gear set, in addition to changing the connection of the elements “carrier” and “ring gear”, the absolute value of the stationary transmission ratio must be increased by the value “one” in order to achieve the same transmission effect.

One type of construction of the planetary gear set system according to the examples aspects of invention includes a first, a second, and a third planetary gear set. The first planetary gear set is designed as a negative or minus gear set, the sun gear of which is permanently rotationally fixed to the ring gear of the second planetary gear set. The second planetary gear set is also designed as a negative or minus gear set. The carrier of the first planetary gear set is permanently rotationally fixed to the carrier of the second planetary gear set. The second planetary gear set is arranged radially within the first planetary gear set.

According example aspects of to the invention, the ring gear of the second planetary gear set forms the ring gear of the third planetary gear set. As a result, a design is achieved, which is even more compact than the related art.

Preferably, the third planetary gear set is designed as a positive or plus gear set. It is particularly preferred when neither the sun gear nor the carrier of the third planetary gear set is connected to one of the elements of the first and the second planetary gear sets.

One alternative type of construction of the planetary gear set system according to example aspects of the invention includes a Ravigneaux gear set with precisely four shafts, and one additional planetary gear set which is designed as a plus gear set. The ring gear of the additional planetary gear set is permanently rotationally fixed to that sun gear of the Ravigneaux gear set, in this case, which intermeshes with the radially outer planet gears of the Ravigneaux gear set. The additional planetary gear set is arranged radially within this sun gear in this case.

Both example embodiments of the planetary gear set system according to the invention are based on the same basic idea, namely that of arranging a third or additional planetary gear set radially within a suitable two-carrier-four-shaft transmission.

One preferred example embodiment of a transmission for a motor vehicle including a planetary gear set system according to the invention includes an input shaft, an interface to a transmission-external drive unit for the power transmission between the transmission-external drive unit and the drive shaft, as well as an output shaft. One section of the output shaft includes a tooth system which is configured for the power transmission between the output shaft and a differential gear arranged axially parallel to the output shaft. The differential gear can be an integral part of the transmission or can be arranged in a separate housing, as a separate assembly.

The interface is designed for transmitting a turning motion from the transmission-external drive unit to the input shaft of the transmission and can be designed, for example, as a flange or as a spline. The interface can be formed on the input shaft or on a connecting shaft which can be connected to the input shaft. The interface can also be formed, for example, on a hydrodynamic torque converter which is connected to the input shaft and acts as a starting component. The output-shaft tooth system is aligned toward driving wheels of the motor vehicle in order to transmit a turning motion from the output shaft, with the intermediate connection of the differential gear. Such an arrangement is particularly suitable for the application of the transmission in a motor vehicle including a drive train aligned in parallel to the direction of travel of the motor vehicle. The power transmission between the output shaft and the differential gear can take place via a spur gear drive having one or multiple spur gear stages, or even via a chain.

Preferably, the planetary gear set system forms the sole gear set system of the transmission, which is configured for implementing gears between the input shaft and the output shaft. Therefore, the transmission includes no gear-implementing gear set other than the planetary gear set system. The exclusion includes not only planetary gear sets, but also spur gear stages. This is the case because the planetary gear set system already includes, at least functionally, three single planetary gear sets, with the aid of which a sufficient gear implementation for a motor vehicle transmission is already possible. A transmission ratio step connected upstream or downstream from the input shaft or the output shaft is not affected by this exclusion.

Preferably, the output-shaft tooth system is arranged axially between the interface to the transmission-external drive unit and the planetary gear set system. As a result, an arrangement of the differential gear close to the transmission-external drive unit is simplified. Such an arrangement of the differential gear is preferred in order to keep the deflection angle in the constant velocity joints of the input shafts between the differential gear and the driving wheels as small as possible.

According to one preferred embodiment, the output-shaft tooth system is arranged axially between a bearing shield of the transmission and the planetary gear set system. The bearing shield is configured, in this case, for accommodating an antifriction bearing, via which a radial and axial support of the output shaft takes place.

Preferably, the transmission includes an electric machine. According to a first variant embodiment, the electric machine is arranged coaxially to the input shaft and is permanently operatively connected thereto, and, in fact, either directly or via an interconnected transmission having a constant transmission ratio. According to a second variant embodiment, the electric machine is arranged axially parallel to the input shaft and is permanently operatively connected to the input shaft via a spur gear drive or via a flexible traction drive mechanism. Examples of flexible traction drive mechanisms are chains, V-belts, or even toothed belts. Due to the particularly compact planetary gear set system, the present transmission is particularly suited for the integration of an electric machine. This is the case because the installation space requirement of the transmission is appropriately enlarged due to the provision of an electric machine.

According to one possible embodiment, the transmission includes a separating clutch. By way of the engagement of the separating clutch, that shaft of the transmission is connected to the input shaft, on which the interface to the transmission-external drive unit is formed. This shaft is also referred to as a connecting shaft. The separating clutch can be designed as a force-locking clutch or as a form-fit clutch. By disengaging the separating clutch, the motor vehicle can be driven by the electric machine in all gears of the transmission without entraining the transmission-external drive unit.

The transmission can include a torsional vibration damper which is configured for damping torsional vibrations and is preferably arranged in the operative connection between two sections of the connecting shaft. The first section of the connecting shaft is associated with the interface to the transmission-external drive unit, and the second section of the connecting shaft is associated with the separating clutch. In this way, torsional vibrations generated by the transmission-external drive unit can be damped toward the input shaft.

A transmission including a planetary gear set system preferably includes five shift elements. The sun gear of the third planetary gear set, which is designed as a plus gear set, is permanently connected to the input shaft in this case. The ring gear of the first planetary gear set is permanently connected to the output shaft. By engaging the first of the five shift elements, the input shaft is connectable to the sun gear of the second planetary gear set. By engaging the second of the five shift elements, the carrier of the third planetary gear set is rotationally fixable. By engaging the third of the five shift elements, the sun gear of the first planetary gear set is rotationally fixable. By engaging the fourth of the five shift elements, the carrier of the first planetary gear set is rotationally fixable. By engaging the fifth of the five shift elements, the input shaft is connectable to the carrier of the first planetary gear set. Due to this type of configuration of the transmission, the implementation of six forward gears and one reverse gear between the input shaft and the output shaft is possibly by way of a selective engagement of the five shift elements in pairs.

Preferably, the second shift element and the third shift element are arranged axially between the interface to the transmission-external drive unit and the output-shaft tooth system. Due to such an arrangement, these two shift elements operating as brakes are to be arranged close to the housing in an easy way.

A transmission including a planetary gear set system preferably also includes five shift elements. The sun gear of the additional planetary gear set is permanently connected to the input shaft. The ring gear of the Ravigneaux gear set is permanently connected to the output shaft. By engaging the first of the five shift elements, the input shaft is connectable to that sun gear of the Ravigneaux gear set, which intermeshes with the radially inner planet gears of the Ravigneaux gear set. By engaging the second of the five shift elements, the carrier of the additional planetary gear set is rotationally fixable. By engaging the third of the five shift elements, that sun gear is rotationally fixable, which intermeshes with the outer planet gears of the Ravigneaux gear set. By engaging the fourth of the five shift elements, the carrier of the Ravigneaux gear set is rotationally fixable. By engaging the fifth of the five shift elements, the carrier of the Ravigneaux gear set is connectable to the input shaft. Due to this type of configuration of the transmission, the implementation of six forward gears and one reverse gear between the input shaft and the output shaft is also possibly by way of a selective engagement of the five shift elements in pairs.

According to one preferred embodiment, the first shift element and/or the fifth shift element are/is arranged axially between the planetary gear set system and an end of the transmission axially opposite the interface to the transmission-external drive unit. Due to such an arrangement, an advantageous oil guidance to hydraulic actuating devices of these shift elements is made possible.

Preferably, the fourth shift element is arranged radially within the antifriction bearing, with the aid of which the output shaft is mounted on the bearing shield. This is advantageous, in particular, when the fourth shift element is designed as a form-fit shift element.

According to one alternative embodiment, the second and the third shift elements can be arranged axially between the planetary gear set system and the end of the transmission axially opposite the interface to the transmission-external drive unit. The first and the fifth shift elements are to be arranged, in this case, axially between the aforementioned interface and the planetary gear set system.

The transmission can be an integral part of a drive train for a motor vehicle. The drive train includes, in addition to the transmission, an internal combustion engine which is torsionally elastically connected or can be torsionally elastically connected to the input shaft of the transmission via the torsional vibration damper. The separating clutch, which can be an integral part of the transmission, can be located between the input shaft and the internal combustion engine. Output shafts of the differential gear are connected to driving wheels of the motor vehicle. If the transmission includes the electric machine, the drive train allows for multiple drive modes of the motor vehicle. In an electric mode, the motor vehicle is driven by the electric machine of the transmission. In an internal combustion engine-operated mode, the motor vehicle is driven by the internal combustion engine. In a hybrid mode, the motor vehicle is driven by the internal combustion engine as well as by the electric machine of the transmission.

A permanent connection is referred to as a connection that always exists between two elements. Elements which are permanently connected in such a way always rotate with the same dependence between their speeds. No shift element may be located in a permanent connection between two elements. A permanent connection is therefore to be distinguished from a shiftable connection. A permanently rotationally fixed connection is referred to as a connection that always exists between two elements and, therefore, the connected elements in the connection always have the same rotational speed.

### BRIEF DESCRIPTION OF THE DRAWINGS

Exemplary embodiments of the invention are described in detail in the following with reference to the attached figures. Wherein:

FIG. 1 shows a schematic cutaway view of a motor vehicle drive train;

FIG. 2 through FIG. 7 show schematic cutaway views of various exemplary embodiments of a transmission;

FIG. 8 shows a structural cutaway view of a transmission;

FIG. 9 shows a shift pattern; and

FIG. 10 and FIG. 11 each show a planetary gear set system according to the invention.

### DETAILED DESCRIPTION

Reference will now be made to embodiments of the invention, one or more examples of which are shown in the drawings. Each embodiment is provided by way of explanation of the invention, and not as a limitation of the invention. For example, features illustrated or described as part of one embodiment can be combined with another embodiment to yield still another embodiment. It is intended that the present invention include these and other modifications and variations to the embodiments described herein.

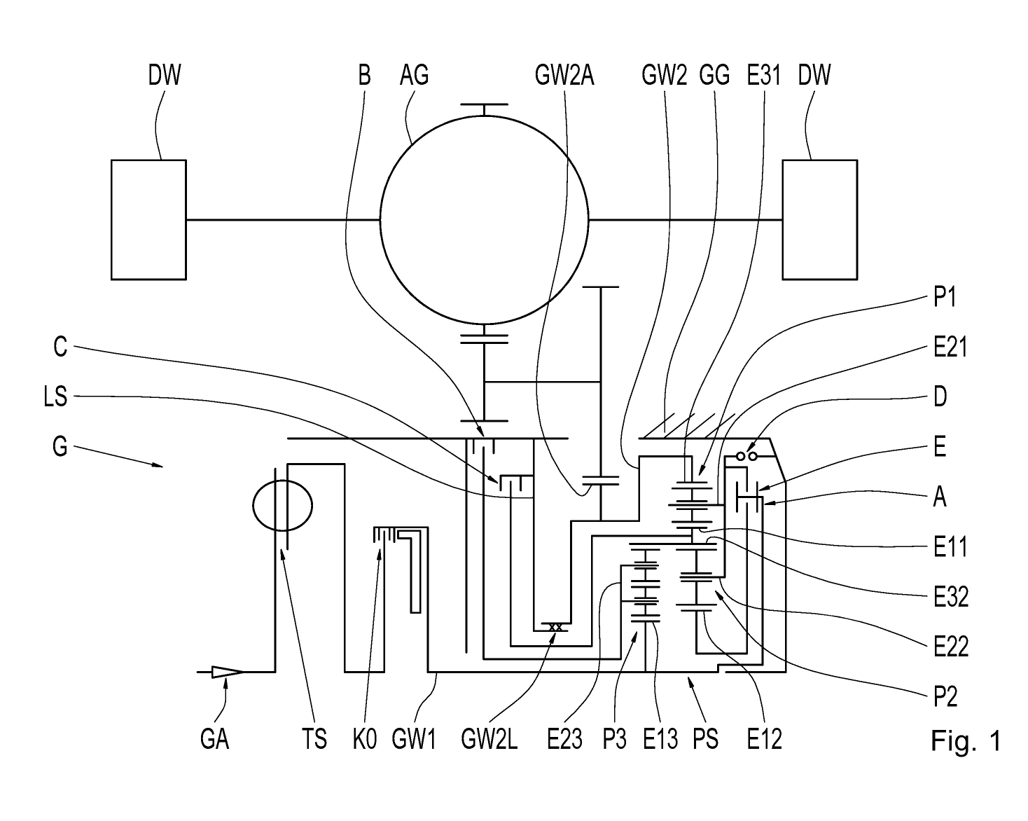

FIG. 1 shows a schematic cutaway view of a motor vehicle drive train which includes a transmission G according to a first exemplary embodiment including a planetary gear set system PS. The transmission G includes, in addition to the planetary gear set system PS, an input shaft GW1, an output shaft GW2, a differential gear AG, a torsional vibration damper TS, a separating clutch KO, five shift elements A, B, C, D, E, as well as a rotationally fixed housing GG including a bearing shield LS attached thereto. The differential gear AG is connected to driving wheels DW of the motor vehicle via drive shafts.

The planetary gear set system PS includes a first planetary gear set P1, a second planetary gear set P2, and a third planetary gear set P3. The first planetary gear set P1 and the second planetary gear set P2 are each designed as a negative or minus gear set, while the third planetary gear set P3 is designed as a positive or plus gear set. A sun gear E13 of the third planetary gear set P3 is permanently connected to the input shaft GW1. A carrier E23 of the third planetary gear set P3 is rotationally fixable by engaging the second shift element B. A sun gear E12 of the second planetary gear set P2 is connectable to the input shaft GW1 by engaging the first shift element A. A carrier E22 of the second planetary gear set P2 is permanently rotationally fixed to a carrier E21 of the first planetary gear set P1 and is rotationally fixable by engaging the fourth shift element D. A ring gear E31 of the first planetary gear set P1 is permanently connected to the output shaft GW2.

A sun gear E11 of the first planetary gear set P1 is permanently rotationally fixed to a ring gear E32 of the second planetary gear set P2, wherein the ring gear E32 is formed on the inner diameter of the sun gear E11. The ring gear E32 also forms the ring gear of the third planetary gear set P3 in this case, and is designed to be appropriately wide. The ring gear E32, and the sun gear E11, is rotationally fixable by engaging the third shift element C.

The transmission G includes an interface GA to a transmission-external drive unit which can be designed, for example, as an internal combustion engine. The interface GA is configured for transmitting a rotational speed of the transmission-external drive unit to the input shaft GW1. A torsional vibration damper TS and a separating clutch KO are arranged between the interface GA and the input shaft GW1. The input shaft GW1 is connectable to the interface GA by engaging the separating clutch KO. An actuating element for actuating the separating clutch KO rests axially against a section of the input shaft GW1.

The output shaft GW2 includes, on one section, a tooth system GW2A which is utilized for the power transmission between the output shaft GW2 and the differential gear AG arranged axially parallel to the output shaft GW2. The tooth system GW2A is preferably designed to have oblique toothing and requires an appropriate mounting. The bearing shield LS is configured for accommodating an antifriction bearing GW2L which is utilized for the radial and axial support of the output shaft GW2.

The second shift element B and the third shift element C are located axially between the interface GA and the bearing shield LS. The output-shaft tooth system GW2A is located axially between the bearing shield LS and the planetary gear set system PS. The planetary gear set system PS is located axially between the output-shaft tooth system GW2A and the first shift element A, the fourth shift element D, and the fifth shift element E.

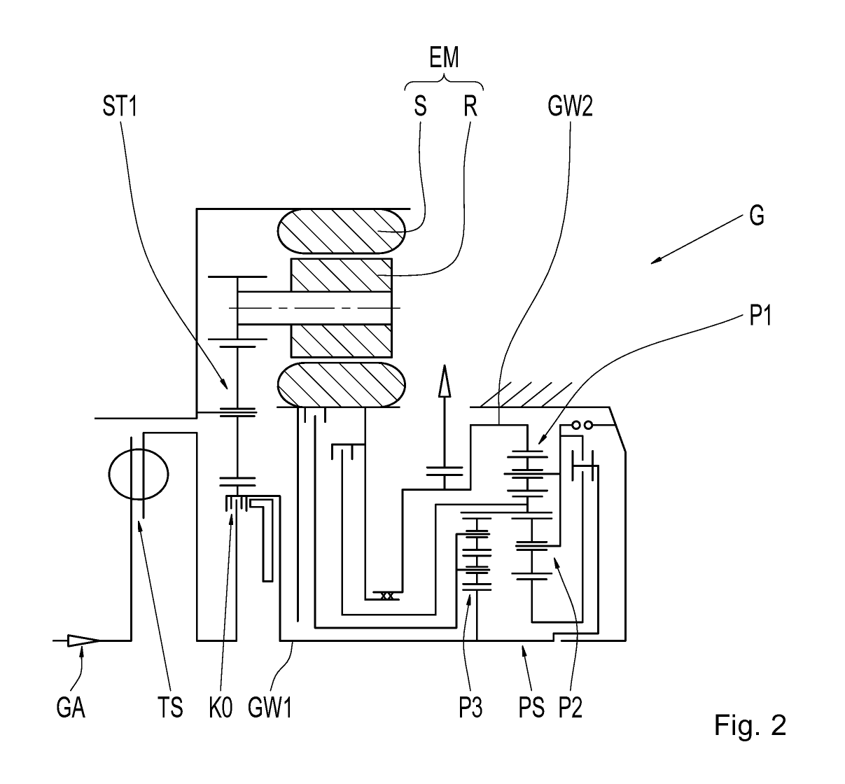

FIG. 2 shows a schematic view of a second exemplary embodiment of the transmission G which essentially corresponds to the first exemplary embodiment represented in FIG. 1. The remaining components of the drive train and the differential gear AG are not represented, for the sake of clarity. In this case, the transmission G includes an electric machine EM including a rotationally fixed stator S and a rotary rotor R which is arranged axially parallel to the input shaft GW1. The rotor R is operatively connected in a fixed transmission ratio to the input shaft GW1 via a spur gear drive ST1. The spur gear drive ST1 is arranged in the same plane as the separating clutch KO in this case. Instead of the spur gear drive ST1, a flexible traction drive mechanism could also be utilized, for example, a chain drive.

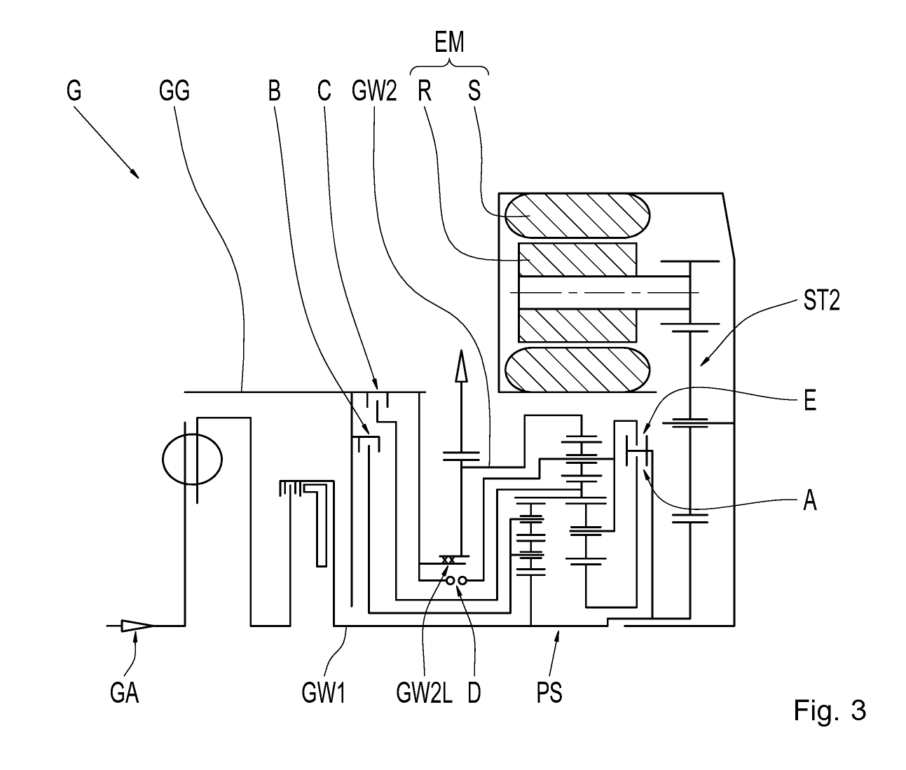

FIG. 3 shows a schematic view of a third exemplary embodiment of the transmission G which essentially corresponds to the second exemplary embodiment represented in FIG. 2. Only the arrangement of the electric machine EM and the arrangement of the fourth shift element D have been changed. The electric machine EM is also arranged axially parallel to the input shaft GW1, although in the rear area of the transmission G, which is axially opposite the interface GA. The connection of the electric machine EM to the input shaft GW1 takes place via a spur gear drive ST2. The fourth shift element D, which is designed as a form-fit brake, is arranged radially within the output shaft bearing GW2L in a space-saving manner in this case.

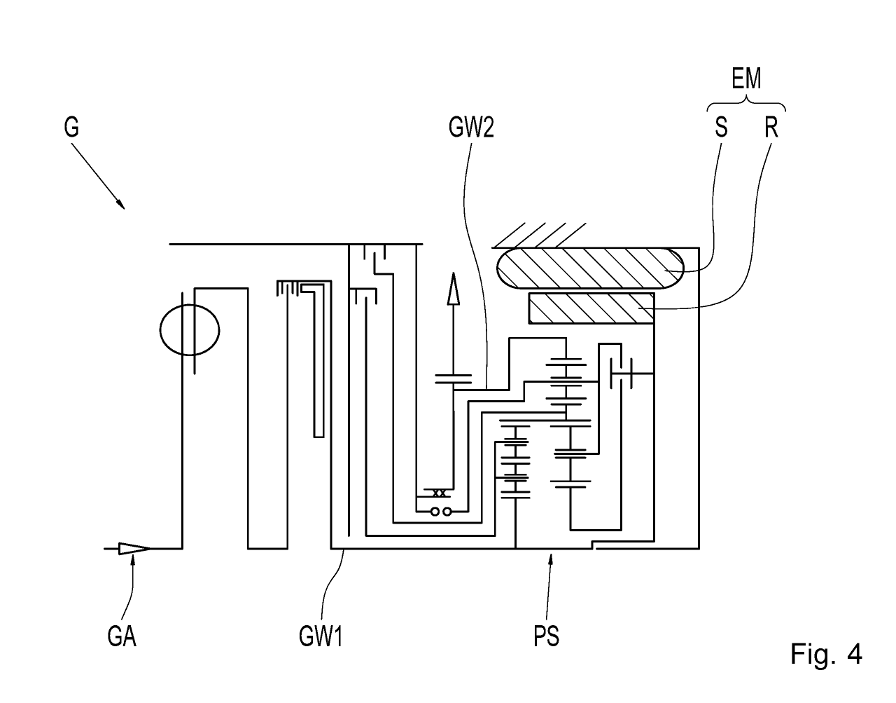

FIG. 4 shows a schematic view of a fourth exemplary embodiment of the transmission G which essentially corresponds to the third exemplary embodiment represented in FIG. 3. Only the arrangement of the electric machine EM has been changed, which is arranged coaxially to the input shaft GW1 in this case. Such an arrangement allows for a better mechanical efficiency of the transmission G, since the spur gear drive ST2 is dispensed with.

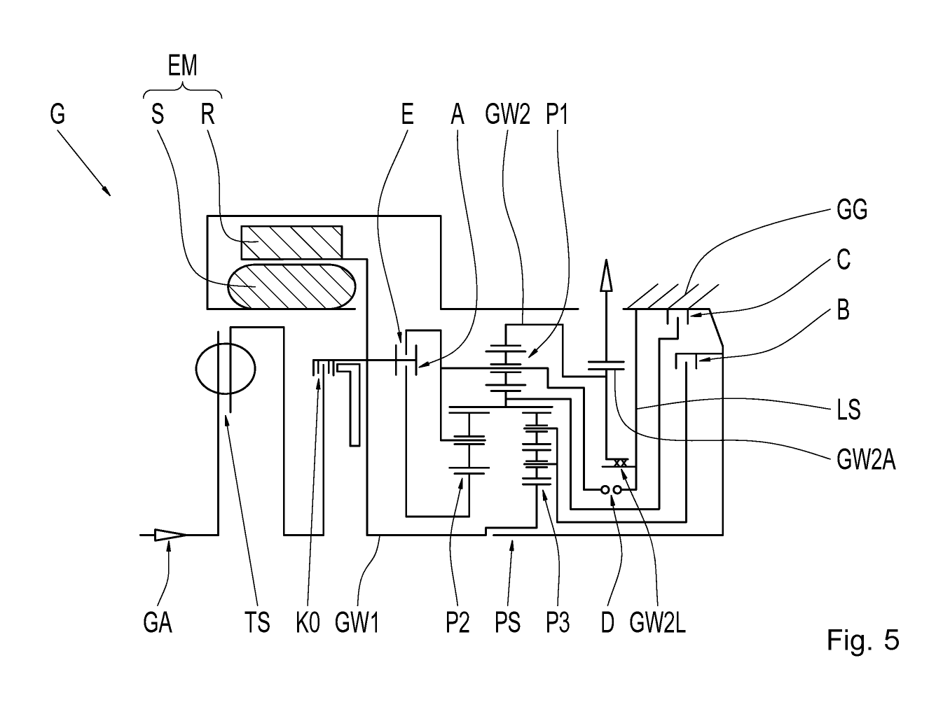

FIG. 5 shows a schematic view of a fifth exemplary embodiment of the transmission G which is distinguished by an arrangement of the transmission components which has been changed as compared to the preceding exemplary embodiments. The planetary gear set system PS is now arranged axially between the interface GA and the output-shaft tooth system GW2A. The electric machine EM is arranged coaxially to the input shaft GW1 and axially between the interface GA and the planetary gear set system PS. The output-shaft tooth system GW2A is arranged axially between the planetary gear set system PS and the bearing shield LS. The first shift element A and the fifth shift element E are arranged axially between the electric machine EM and the planetary gear set system PS. The fourth shift element D is arranged radially within the output shaft bearing GW2L. The bearing shield LS is arranged axially between the output-shaft tooth system GW2A and the second shift element B and the third shift element C.

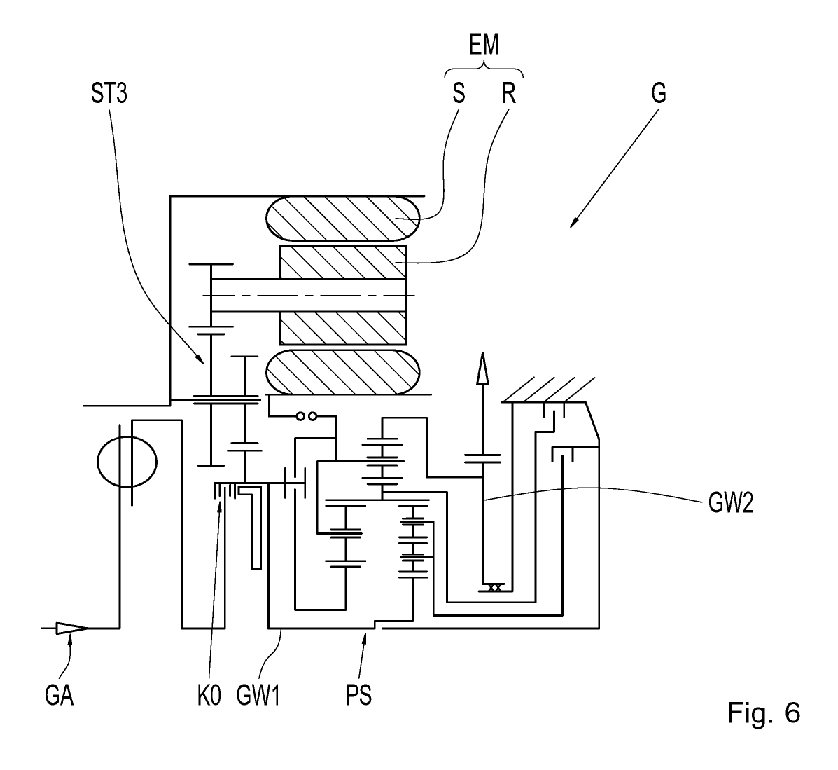

FIG. 6 shows a schematic view of a sixth exemplary embodiment of the transmission G which essentially corresponds to the fifth exemplary embodiment represented in FIG. 5. The electric machine EM is arranged axially parallel to the input shaft GW1 in this case, and is operatively connected to the input shaft GW1 via a spur gear drive ST3. The spur gear drive ST3 is designed as a two-stage spur gear drive in this case. Elements of the spur gear drive ST3 are arranged together with the separating clutch KO in a shared plane.

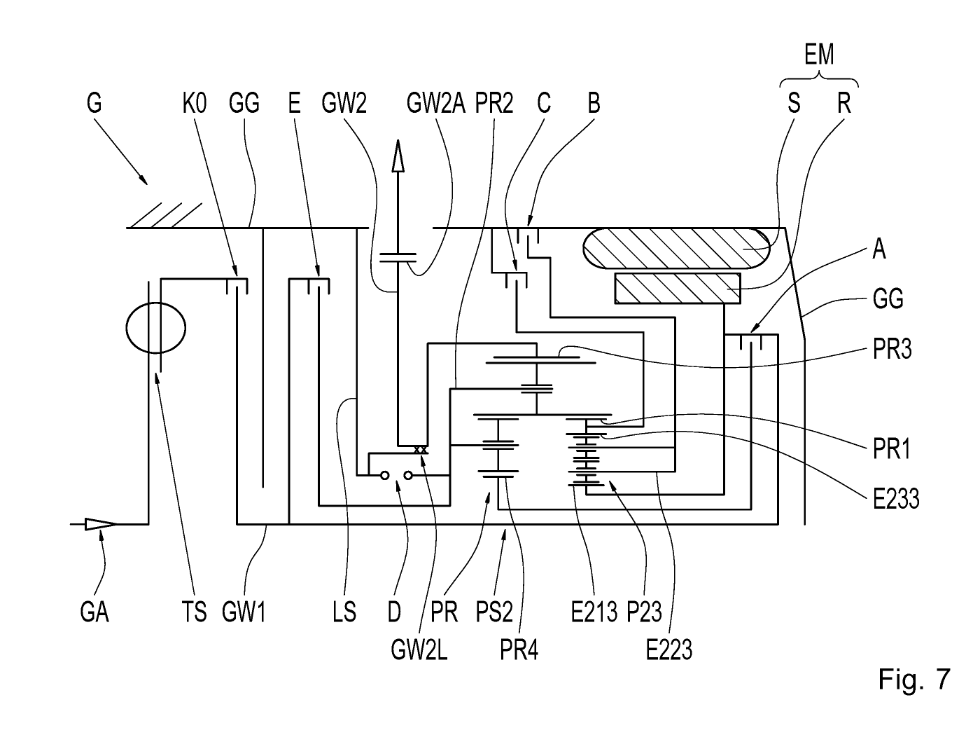

FIG. 7 shows a schematic view of a seventh exemplary embodiment of the transmission, which is distinguished by a differently designed planetary gear set system PS2. The planetary gear set system PS2 includes a Ravigneaux gear set PR and an additional planetary gear set P23 which is designed as a plus gear set. A sun gear PR1 of the Ravigneaux gear set, which intermeshes with its outer planet gears, is designed to be integral with a ring gear E233 of the additional planetary gear set P23. The additional planetary gear set P23 is arranged radially within the sun gear PR1 in this case. By engaging the first shift element A, the input shaft GW1 is connected to a sun gear PR4 of the Ravigneaux gear set PR, which intermeshes with its radially inner planet gears. By engaging the second shift element B, a carrier E223 of the additional planetary gear set P23 is rotationally fixed. By engaging the third shift element C, the sun gear PR1 is rotationally fixed. By engaging the fourth shift element D, a common carrier PR2 of the Ravigneaux gear set PR is rotationally fixed. By engaging the fifth shift element E, the input shaft GW1 is connected to the carrier PR2. A ring gear PR3 of the Ravigneaux gear set PR is permanently connected to the output shaft GW2.

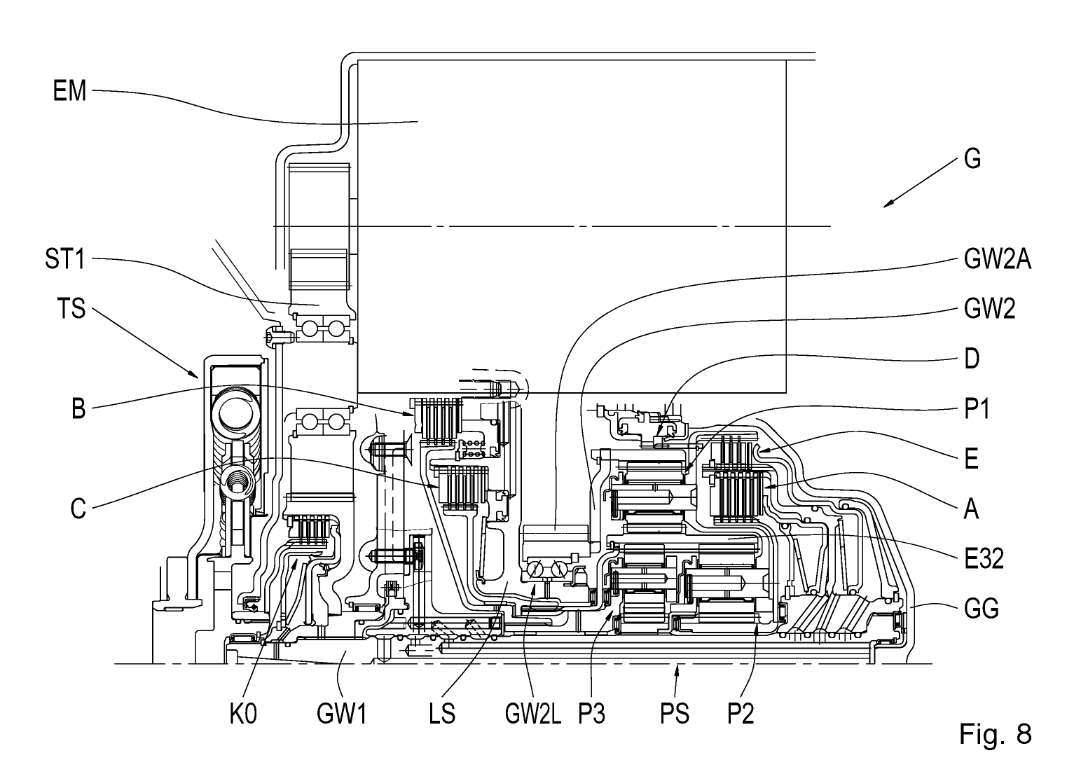

FIG. 8 shows a structural cutaway view of the second exemplary embodiment of the transmission G represented in FIG. 2. For greater clarity, two cutting planes of the transmission G are presented in FIG. 8 in one plane, namely a cutting plane through the axially parallel electric machine EM and a cutting plane through the planetary gear set system PS, the further elements of the transmission G arranged coaxially thereto, and one portion of the spur gear drive ST1. The two cutting planes are combined in the area of the spur gear drive ST1, whereby the spur gear drive ST1 appears to be non-rotationally symmetrical. Sections of the housing GG, the differential gear AG, and the intermediate shaft between the differential gear AG and the output shaft GW2 are not represented. The structural cutaway view makes it clear that, due to the utilization of the planetary gear set system PS according to the invention, a transmission G including an electric machine EM requires a particularly small amount of axial installation space.

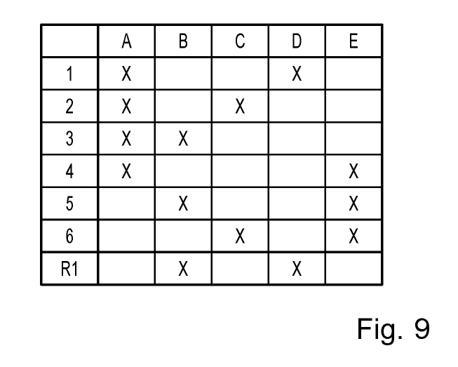

FIG. 9 shows a shift pattern which can be applied for all exemplary embodiments of the transmission G. Six forward gears 1 through 6 and one reverse gear R1 are indicated in the rows of the shift pattern. In the columns of the shift pattern, an X indicates which of the shift elements A, B, C, D, E is engaged in which forward gear 1 through 6, and in the reverse gear R1. The gears 1 through 6 relate to fixed speed ratios between the input shaft GW1 and the output shaft GW2.

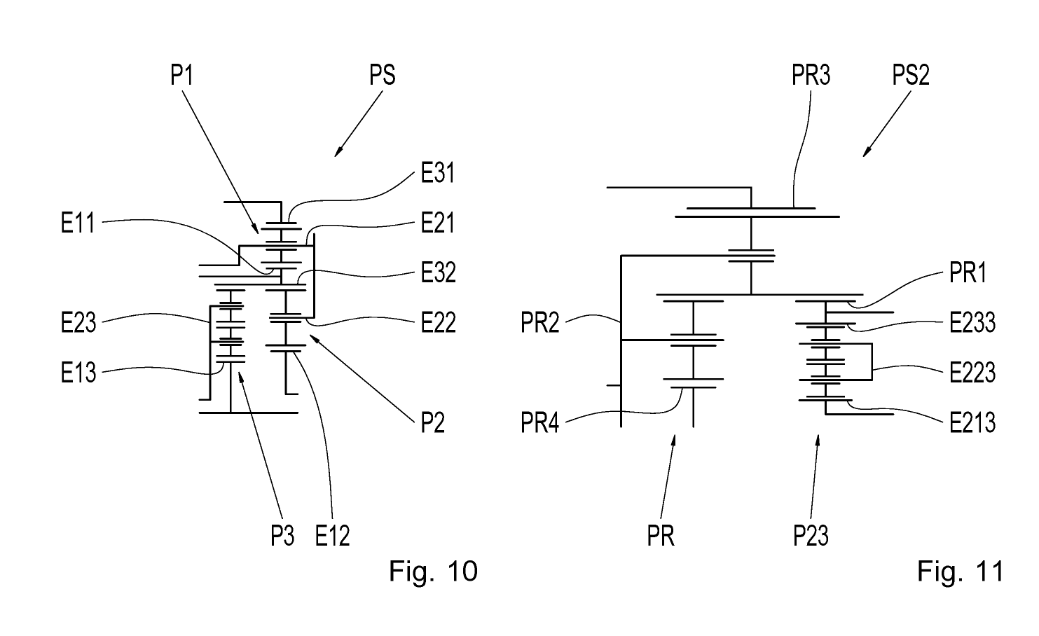

FIG. 10 shows an isolated representation of the planetary gear set system PS including its elements sun gear E11, carrier E21, and ring gear E31 of the first planetary gear set P1, sun gear E12, carrier E22, and ring gear E32 of the second planetary gear set P2, as well as sun gear E13 and carrier E23 of the third planetary gear set P3. The third planetary gear set P3 is designed as a plus gear set in this case, merely by way of example.

FIG. 11 shows an isolated representation of the planetary gear set system PS2 including its elements sun gear PR1, sun gear PR2, carrier PR30 and ring gear PR4 of the Ravigneaux gear set PR, as well as sun gear E213, carrier E223, and ring gear E233 of the additional planetary gear set P23.

Modifications and variations can be made to the embodiments illustrated or described herein without departing from the scope and spirit of the invention as set forth in the appended claims.

### REFERENCE CHARACTERS

PS planetary gear set system
P1 first planetary gear set
E11 sun gear of the first planetary gear set
E21 carrier of the first planetary gear set
E31 ring gear of the first planetary gear set
P2 second planetary gear set
E12 sun gear of the second planetary gear set
E22 carrier of the second planetary gear set
E32 ring gear of the second planetary gear set
P3 third planetary gear set
E13 sun gear of the third planetary gear set
E23 carrier of the third planetary gear set
PS2 planetary gear set system
PR Ravigneaux gear set
PR1 sun gear of the Ravigneaux gear set
PR2 carrier of the Ravigneaux gear set
PR3 ring gear of the Ravigneaux gear set
PR4 sun gear of the Ravigneaux gear set
P23 additional planetary gear set
E213 sun gear of the additional planetary gear set
E223 carrier of the additional planetary gear set
E233 ring gear of the additional planetary gear set
G transmission
GW1 input shaft
GW2 output shaft
GW2A output-shaft tooth system
GW2L antifriction bearing
GA interface
GG transmission housing
LS bearing shield
EM electric machine
S stator
R rotor
AG differential gear
DW driving wheel
KO separating clutch
TS torsional vibration damper
A first shift element
B second shift element
C third shift element
D fourth shift element
E fifth shift element
ST1 spur gear drive
ST2 spur gear drive
ST3 spur gear drive
1 first forward gear
2 second forward gear
3 third forward gear
4 fourth forward gear
5 fifth forward gear
6 sixth forward gear
R1 reverse gear

1-17: (canceled)

18. A planetary gear set system (PS) for a motor vehicle transmission (G), comprising:
a first planetary gear set (P1) that is a minus gear set, a carrier (E21) of the first planetary gear set (P1) is permanently rotationally fixed;
a second planetary gear set (P2) that is a minus gear set, a sun gear (E11) of the first planetary gear set (P1) is permanently rotationally fixed to a ring gear (E32) of the second planetary gear set (P2), a carrier (E22) of the second planetary gear set (P2) is permanently rotationally fixed, the second planetary gear set (P2) is situated radially within the first planetary gear set (P1); and
a third planetary gear set (P3);
wherein the ring gear (E32) of the second planetary gear set (P2) forms a ring gear of the third planetary gear set (P3).

19. The planetary gear set system (PS) of claim 18, wherein the third planetary gear set (P3) is a plus gear set.

20. The planetary gear set system (PS) of claim 18, wherein neither a sun gear (E13) of the third planetary gear set (P3) nor a carrier (E23) of the third planetary gear set (P3) is permanently rotationally fixed to one of the gears (E11, E21, E31, E12, E22, E32) of the first planetary gear set (P1) and the second planetary gear set (P2).

21. A planetary gear set system (PS2) for a motor vehicle transmission (G), comprising:
a Ravigneaux gear set (PR) with precisely four shafts;
an additional planetary gear set (P23) which is a plus gear set,
wherein a ring gear (E233) of the additional planetary gear set (P23) is permanently rotationally fixed to a sun gear (PR1) of the Ravigneaux gear set (PR), the sun gear (PR1) of the Ravigneaux gear set (PR) that intermeshes with radially outer planet gears of the Ravigneaux gear set (PR), and the additional planetary gear set (P23) is arranged radially within the sun gear (PR1) of the Ravigneaux gear set (PR).

22. A transmission (G) for a motor vehicle, comprising:
the planetary gear set system (PS) of claim 18,
an input shaft (GW1);
an interface (GA) configured for power transmission from a transmission-external drive unit to the input shaft (GW1); and
an output shaft (GW2), one section of the output shaft (GW2) comprising a tooth system (GW2A) configured for power transmission between the output shaft (GW2) and a transmission-internal or transmission-external differential gear (AG) arranged axially parallel to the output shaft (GW2).

23. The transmission (G) of claim 22, wherein the planetary gear set system (PS) forms the sole gear set system of the transmission (G) configured for implementing different gear ratios between the input shaft (GW1) and the output shaft (GW2).

24. The transmission (G) of claim 22, wherein the tooth system (GW2A) is arranged axially between the interface (GA) and the planetary gear set system (PS).

25. The transmission (G) of claim 22, wherein the tooth system (GW2A) is arranged axially between a bearing shield (LS) and the planetary gear set system (PS), and the bearing shield (LS) accommodates an antifriction bearing (GW2L) configured for radial and axial support of the output shaft (GW2).

26. The transmission (G) of claim 25, wherein a fourth shift element (D) is arranged radially within the antifriction bearing (GW2L).

27. The transmission (G) of claim 22, further comprising an electric machine (EM), wherein:
the electric machine (EM) is arranged coaxially to the input shaft (GW1) and is permanently operatively connected to the input shaft (GW1); or
the electric machine (EM) is arranged axially parallel to the input shaft (GW1) and is permanently operatively connected to the input shaft (GW1) via a spur gear drive (ST1, ST2, ST3) or via a flexible traction drive mechanism.

28. The transmission (G) of claim 22, further comprising a separating clutch (KO), wherein a shaft on which the interface (GA) is formed is connectable to the input shaft (GW1) with the separating clutch (KO).

29. A drive train for a motor vehicle, comprising:
an internal combustion engine (VKM);
the transmission (G) of claim 28; and
a transmission-internal or transmission-external torsional vibration damper (TS);
wherein the input shaft (GW1) of the transmission (G) is torsionally elastically connected via the transmission-internal or transmission-external torsional vibration damper (TS) to the internal combustion engine (VKM) either directly or via the separating clutch (KO), and driving wheels (DW) of the motor vehicle are connected to output shafts of the differential gear (AG).

30. The transmission (G) of claim 22, further comprising a plurality of shift elements with a first shift element (A), a second shift element (B), a third shift element (C), a fourth shift element (D), and a fifth shift element (E), wherein:
a sun gear (E13) of the third planetary gear set (P3) is permanently connected to the input shaft (GW1);
a ring gear (E31) of the first planetary gear set (P1) is permanently connected to the output shaft (GW2);
the input shaft (GW1) is connectable to a sun gear (E12) of the second planetary gear set (P2) by engaging the first shift element (A);
the third planetary gear set (P3) is a plus gear set;
a carrier (E23) of the third planetary gear set (P3) is rotationally fixable by engaging the second shift element (B);
the sun gear (E11) of the first planetary gear set (P1) is rotationally fixable by engaging the third shift element (C);
the carrier (E21) of the first planetary gear set (P1) is rotationally fixable by engaging the fourth shift element (D); and
the input shaft (GW1) is connectable to the carrier (E21) of the first planetary gear set (P1) by engaging the fifth shift element (E).

31. The transmission (G) of claim 30, wherein the second shift element (B) and the third shift element (C) are arranged axially between the interface (GA) and the tooth system (GW2A).

32. The transmission (G) of claim 30, wherein one or both of the first shift element (A) and the fifth shift element (E) is arranged axially between the planetary gear set system (PS) and an axial end of the transmission (G) opposite the interface (GA).

33. The transmission (G) of claim 30, wherein the second shift element (B) and the third shift element (C) are arranged axially between the planetary gear set system (PS) and an axial end of the transmission (G) opposite the interface (GA), and the first shift element (A) and the fifth shift element (E) are arranged axially between the interface (GA) and the planetary gear set system (PS).

34. A transmission (G) for a motor vehicle, comprising:
the planetary gear set system (PS2) of claim 21,
an input shaft (GW1);
an interface (GA) configured for power transmission from a transmission-external drive unit to the input shaft (GW1); and
an output shaft (GW2), one section of the output shaft (GW2) comprising a tooth system (GW2A) configured for power transmission between the output shaft (GW2) and a transmission-internal or transmission-external differential gear (AG) arranged axially parallel to the output shaft (GW2).

35. The transmission (G) of claim 34, wherein the planetary gear set system (PS2) forms the sole gear set system of the transmission (G) configured for implementing different gear ratios between the input shaft (GW1) and the output shaft (GW2).

36. The transmission (G) of claim 34, wherein the tooth system (GW2A) is arranged axially between the interface (GA) and the planetary gear set system (PS2).

37. The transmission (G) of claim 34, wherein the tooth system (GW2A) is arranged axially between a bearing shield (LS) and the planetary gear set system (PS2), and the bearing shield (LS) accommodates an antifriction bearing (GW2L) configured for radial and axial support of the output shaft (GW2).

38. The transmission (G) of claim 34, wherein a fourth shift element (D) is arranged radially within the antifriction bearing (GW2L).

39. The transmission (G) of claim 34, further comprising an electric machine (EM), wherein:
the electric machine (EM) is arranged coaxially to the input shaft (GW1) and is permanently operatively connected to the input shaft (GW1); or
the electric machine (EM) is arranged axially parallel to the input shaft (GW1) and is permanently operatively connected to the input shaft (GW1) via a spur gear drive (ST1, ST2, ST3) or via a flexible traction drive mechanism.

40. The transmission (G) of claim 34, further comprising a separating clutch (KO), wherein a shaft on which the interface (GA) is formed is connectable to the input shaft (GW1) with the separating clutch (KO).

41. A drive train for a motor vehicle, comprising:
an internal combustion engine (VKM);
the transmission (G) of claim 40; and
a transmission-internal or transmission-external torsional vibration damper (TS);
wherein the input shaft (GW1) of the transmission (G) is torsionally elastically connected via the transmission-internal or transmission-external torsional vibration damper (TS) to the internal combustion engine (VKM) either directly or via the separating clutch (KO), and driving wheels (DW) of the motor vehicle are connected to output shafts of the differential gear (AG).

42. The transmission (G) of claim 34, further comprising a plurality of shift elements with a first shift element (A), a second shift element (B), a third shift element (C), a fourth shift element (D), and a fifth shift element (E), wherein:
a sun gear (E213) of the additional planetary gear set (P23) is permanently connected to the input shaft (GW1);
a ring gear (PR3) of the Ravigneaux gear set (PR) is permanently connected to the output shaft (GW2);
the input shaft (GW1) is connectable to a sun gear (PR4) of the Ravigneaux gear set (PR) that intermeshes with radially inner planet gears of the Ravigneaux gear set (PR) by engaging the first shift element (A);
a carrier (E223) of the additional planetary gear set (P23) is rotationally fixable by engaging the second shift element (B);
the sun gear (PR1) of the Ravigneaux gear set (PR) that intermeshes with the radially outer planet gears of the Ravigneaux gear set (PR) is rotationally fixable by engaging the third shift element (C);
a carrier (PR2) of the Ravigneaux gear set (PR) is rotationally fixable by engaging the fourth shift element (D); and
the input shaft (GW1) is connectable to the carrier (PR2) of the Ravigneaux gear set (PR) by engaging the fifth shift element (E).

43. The transmission (G) of claim 42, wherein one or both of the first shift element (A) and the fifth shift element (E) is arranged axially between the planetary gear set system (PS2) and an axial end of the transmission (G) opposite the interface (GA).
